(19) United States
(12) Patent Application Publication
(10) Pub. No.: US 2009/0095121 A1
(43) Pub. Date: Apr. 16, 2009

(54) STEERING WHEEL COVER

(76) Inventor: Yuan-Yuan Huang, Tainan Hsien (TW)

Correspondence Address: LADAS & PARRY LLP, 224 SOUTH MICHIGAN AVENUE, SUITE 1600, CHICAGO, IL, 60604, US

(21) Appl. No.: 11/872,830

(22) Filed: Oct. 16, 2007

(51) Int. Cl. B62D 1/06

(52) U.S. Cl. 74/558

(57) ABSTRACT

A steering wheel cover includes: a wheel sleeve having an inner wall that defines an inner space which is adapted to receive a steering wheel therein, the wheel sleeve further has a radial cross section that has first and second circumferential ends; and a plurality of anti-slip ribs formed on the inner wall of the wheel sleeve. Each of the anti-slip ribs extends from the first circumferential end to the second circumferential end of the radial cross section and radiates inwardly from the inner wall of the wheel sleeve into the inner space in the wheel sleeve.

### BACKGROUND OF THE INVENTION

1. Field of the Invention

This invention relates to a steering wheel cover, more particularly to a steering wheel cover including a plurality of anti-slip ribs formed on an inner wall of a wheel sleeve.

2. Description of the Related Art

A conventional steering wheel cover for a steering wheel usually has an inner surface that is textured for providing friction between the steering wheel cover and the steering wheel during operation of the steering wheel. However, the friction provided by the textured inner surface of the steering wheel cover is still insufficient. In addition, the conventional steering wheel cover is normally made from a synthetic material which tends to deform and deteriorate after a period of use.

### SUMMARY OF THE INVENTION

Therefore, the object of the present invention is to provide a steering wheel cover that can overcome the aforesaid drawbacks associated with the prior art.

According to the present invention, a steering wheel cover comprises: a wheel sleeve having an inner wall that defines an inner space which is adapted to receive a steering wheel therein, the wheel sleeve further having a radial cross section that has first and second circumferential ends; and a plurality of anti-slip ribs formed on the inner wall of the wheel sleeve. Each of the anti-slip ribs extends from the first circumferential end to the second circumferential end of the radial cross section and radiates inwardly from the inner wall of the wheel sleeve into the inner space in the wheel sleeve.

### BRIEF DESCRIPTION OF THE DRAWINGS

In drawings which illustrate embodiments of the invention,

FIG. 1 is a fragmentary perspective view of the first preferred embodiment of a steering wheel cover according to this invention;

FIG. 2 is a fragmentary partly sectional view of the first preferred embodiment; and

FIG. 3 is a fragmentary perspective view of the second preferred embodiment of a steering wheel cover according to this invention.

### DETAILED DESCRIPTION OF THE PREFERRED EMBODIMENTS

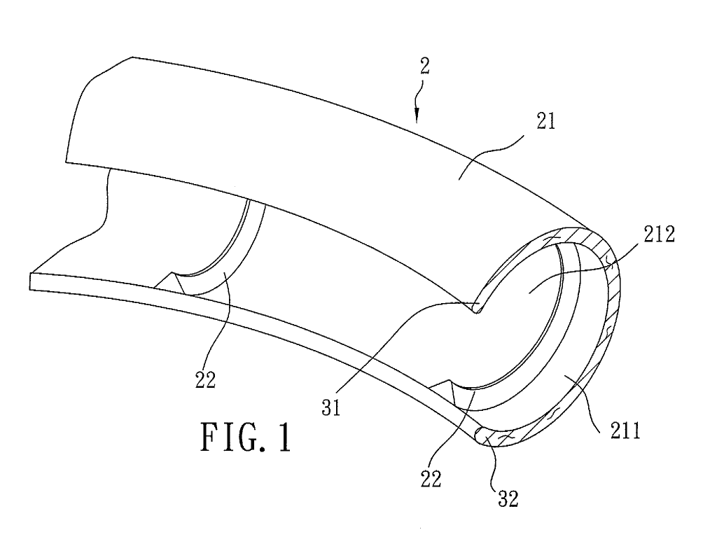

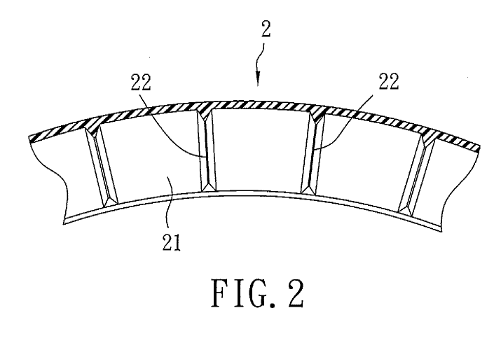

FIGS. 1 and 2 illustrate the first preferred embodiment of a steering wheel cover 2 according to this invention.

The steering wheel cover 2 includes: a wheel sleeve 21 having an inner wall 211 that defines an inner space 212 which is adapted to receive a steering wheel (not shown) therein, the wheel sleeve 21 further having a generally C-shaped radial cross section that has first and second circumferential ends 31, 32; and a plurality of anti-slip ribs 22 formed on the inner wall 211 of the wheel sleeve 21. Each of the anti-slip ribs 22 extends from the first circumferential end 31 to the second circumferential end 32 of the radial cross section and radiates inwardly from the inner wall 211 of the wheel sleeve 21 into the inner space 212 in the wheel sleeve 21.

Preferably, each of the anti-slip ribs 22 is tapered radially and inwardly relative to the inner wall 211 of the wheel sleeve 21.

In this embodiment, each of the anti-slip ribs 22 has a trapezoid cross section. Alternatively, the cross section of the anti-slip ribs 22 can be rectangular, triangular or semi-oval in shape.

Preferably, the anti-slip ribs 22 are made from a flexible material, such as plastic or rubber.

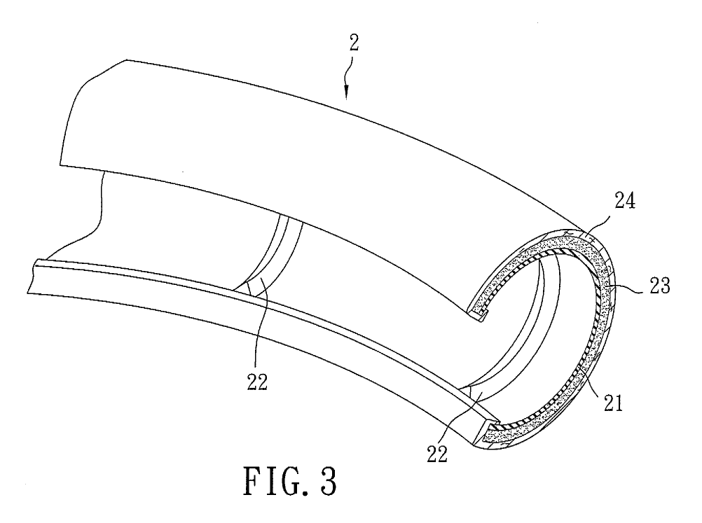

FIG. 3 illustrates the second preferred embodiment of the steering wheel cover 2 according to this invention. The second preferred embodiment differs from the previous embodiment in that the steering wheel cover 2 further includes a cushioning layer 23 that is formed on the wheel sleeve 21 and that is made from a foam material, and a skin layer 24 that is made from leather and that is formed on the cushioning layer 23.

In use, when the wheel sleeve 21 is sleeved on the steering wheel, the anti-slip ribs 22 made from a flexible material are pressed by the steering wheel and the wheel sleeve 21, which results in slight deformation of the anti-slip ribs 22, thereby enhancing the friction between the steering wheel cover 2 and the steering wheel. Moreover, the anti-slip ribs 22 can enhance the structural strength of the wheel sleeve 21 and prevent the wheel sleeve 21 from deformation, thereby prolonging the service life of the steering wheel cover 2.

With the inclusion of the anti-slip ribs 22 in the steering wheel cover 2 of this invention, the aforesaid drawbacks associated with the conventional steering wheel cover can be eliminated.

With the invention thus explained, it is apparent that various modifications and variations can be made without departing from the spirit of the present invention. It is therefore intended that the invention be limited only as recited in the appended claims.

What is claimed is:

1. A steering wheel cover comprising:
a wheel sleeve having an inner wall that defines an inner space which is adapted to receive a steering wheel therein, said wheel sleeve further having a radial cross section that has first and second circumferential ends; and
a plurality of anti-slip ribs formed on said inner wall of said wheel sleeve, each of said anti-slip ribs extending from said first circumferential end to said second circumferential end of said radial cross section and radiating inwardly from said inner wall of said wheel sleeve into said inner space in said wheel sleeve.

2. The steering wheel cover of claim 1, wherein each of said anti-slip ribs is tapered radially and inwardly relative to said inner wall of said wheel sleeve.

3. The steering wheel cover of claim 1, wherein said anti-slip ribs are made from a flexible material.

4. The steering wheel cover of claim 1, further comprising a cushioning layer formed on said wheel sleeve and made from a foam material.

5. The steering wheel cover of claim 4, further comprising a skin layer formed on said cushioning layer and made from leather.
